(19) United States
(12) Patent Application Publication
(10) Pub. No.: US 2024/0045852 A1
(43) Pub. Date: Feb. 8, 2024

(54) PERFORMING AN OPERATION IN A TREE STRUCTURE

(71) Applicant: INTERNATIONAL BUSINESS MACHINES CORPORATION, Armonk, NY (US)

(72) Inventors: Shuo Li, Beijing (CN); Xiaobo Wang, Beijing (CN); Leilei Li, San Jose, CA (US); Ping Wang, San Jose, CA (US); Sheng Yan Sun, Beijing (CN)

(21) Appl. No.: 17/883,514

(22) Filed: Aug. 8, 2022

(51) Int. Cl. G06F 16/23; G06F 16/22; G06F 16/242

(52) U.S. Cl. CPC G06F 16/2358; G06F 16/2246; G06F 16/244

(57) ABSTRACT

A computer-implemented method for performing an operation in a tree structure is provided according to embodiments of the present disclosure. In the computer-implemented method, an operation to be performed in a tree structure may be received. The tree structure may comprise a plurality of non-leaf nodes and a plurality of leaf nodes. The operation may be associated with a record comprising a pair of key and value. One of the non-leaf nodes may be determined based on the key of the record. Then, the operation may be performed in the determined non-leaf node.

### BACKGROUND

The present invention relates to data processing, and more specifically, to performing an operation in a tree structure.

Relational databases store data by organizing the data into predefined data categories in a form of related tables. The data within the relational databases may be accessed through a query by using high-level query languages, such as Structured Query Language (SQL). The query, which may be represented by a SQL statement, denominates a set of commands for retrieving data from the relational databases. Moreover, other operations, such as insertion or deletion of data, can also be performed on the relational databases through SQL statements.

The performance of the SQL statement can be enhanced through the use of indexes in accessing rows of the tables more efficiently. An index may comprise an ordered set of pointers to the data in the table, i.e., it orders values of columns in the table.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

According to one embodiment of the present invention, there is provided a computer-implemented method for performing an operation in a tree structure. In the computer-implemented method, an operation to be performed in a tree structure may be received. The tree structure may comprise a plurality of non-leaf nodes and a plurality of leaf nodes. The operation may be associated with a record comprising a key and value pair. One of the non-leaf nodes may be determined based on the key of the record. Subsequently, the operation may be performed in the determined non-leaf node.

According to another embodiment of the present invention, there is provided an apparatus for performing an operation in a tree structure. The apparatus may comprise one or more processing units, a memory coupled to at least one of the processing units, and a set of computer program instructions stored in the memory. The set of computer program instructions may be executed by at least one of the processing units to perform the above computer-implemented method.

According to another embodiment of the present disclosure, there is provided a computer program product for performing an operation in a tree structure. The computer program product may comprise a computer readable storage medium having program instructions embodied therewith. The program instructions executable by a processor causes the processor to perform the above computer-implemented method.

In addition to the exemplary aspects and embodiments described above, further aspects and embodiments will become apparent by reference to the drawings and by study of the following descriptions.

### BRIEF DESCRIPTION OF THE SEVERAL VIEWS OF THE DRAWINGS

Through the more detailed description of some embodiments of the present disclosure in the accompanying drawings, the same reference generally refers to the same components in the embodiments of the present disclosure.

FIG. 1 depicts a cloud computing node according to an embodiment of the present invention.

FIG. 2 depicts a cloud computing environment according to an embodiment of the present invention.

FIG. 3 depicts abstraction model layers according to an embodiment of the present invention.

FIG. 4 depicts a schematic flowchart illustrating a method for performing an operation in a tree structure according to some embodiments of the present invention.

FIG. 5 depicts an illustrative diagram of a tree structure according to some embodiments of the present invention.

FIG. 6 depicts a schematic flowchart of an exemplary process for performing an insertion operation according to some embodiments of the present invention.

FIG. 7 depicts an illustrative diagram of a B+ tree according to some embodiments of the present invention.

FIG. 8 depicts a schematic flowchart of an exemplary process for performing a deletion or update operation according to some embodiments of the present invention.

FIG. 9 depicts an illustrative diagram of a B+ tree according to some embodiments of the present invention.

FIG. 10 depicts an illustrative diagram of a B+ tree according to some embodiments of the present invention.

### DETAILED DESCRIPTION

Some embodiments will be described in more detail with reference to the accompanying drawings, in which the embodiments of the present disclosure have been illustrated. However, the present disclosure can be implemented in various manners should not be construed as limited to the embodiments disclosed herein.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction by a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly release to quickly scale in. To the consumer, the capabilities available for provisioning often appear to be unlimited and can be purchased in any quantity, at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more cloud types (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

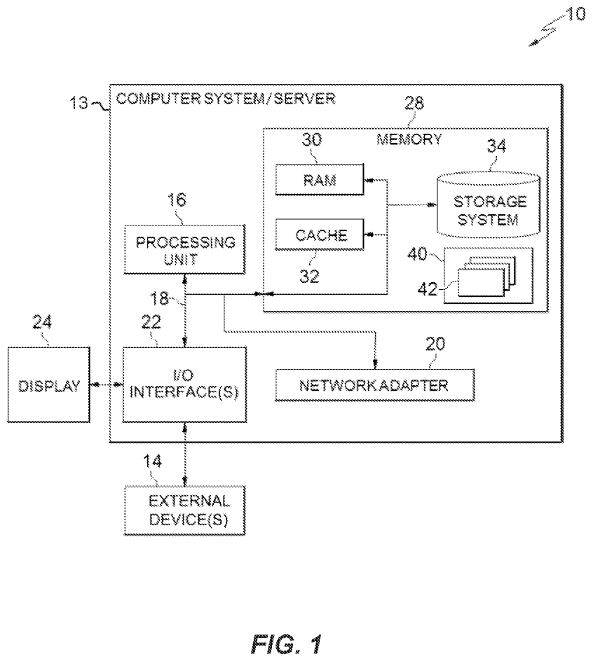

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 13 or a portable electronic device such as a communication device, which is operational with numerous other general purpose or special purpose computing system environments or configurations. Examples of well-known computing systems, environments, and/or configurations that may be suitable for use with computer system/server 13 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 13 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 13 may operate in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 13 in cloud computing node 10 is shown in the form of a general-purpose computing device. The components of computer system/server 13 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 13 typically includes a variety of computer system readable media. Such media may be any available media that is accessible by computer system/server 13, and it includes both volatile and non-volatile media, removable and non-removable media.

System memory 28 can include computer system readable media in the form of volatile memory, such as random access memory (RAM) 30 and/or cache memory 32. Computer system/server 13 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 13 may also communicate with one or more external devices 14 such as a keyboard, a pointing device, a display 24, etc.; one or more devices that enable a user to interact with computer system/server 13; and/or any devices (e.g., network card, modem, etc.) that enable computer system/server 13 to communicate with one or more other computing devices. Such communication can occur via Input/Output (I/O) interfaces 22. In some embodiments, computer system/server 13 can communicate with one or more networks such as a local area network (LAN), a general wide area network (WAN), and/or a public network (e.g., the Internet) via network adapter 20. As depicted, network adapter 20 communicates with the other components of computer system/server 13 via bus 18. Although not shown in FIG. 1, it should be understood that other hardware and/or software components could be used in conjunction with computer system/server 13. Examples, include, but are not limited to: microcode, device drivers, redundant processing units, external disk drive arrays, RAID systems, tape drives, and data archival storage systems, etc.

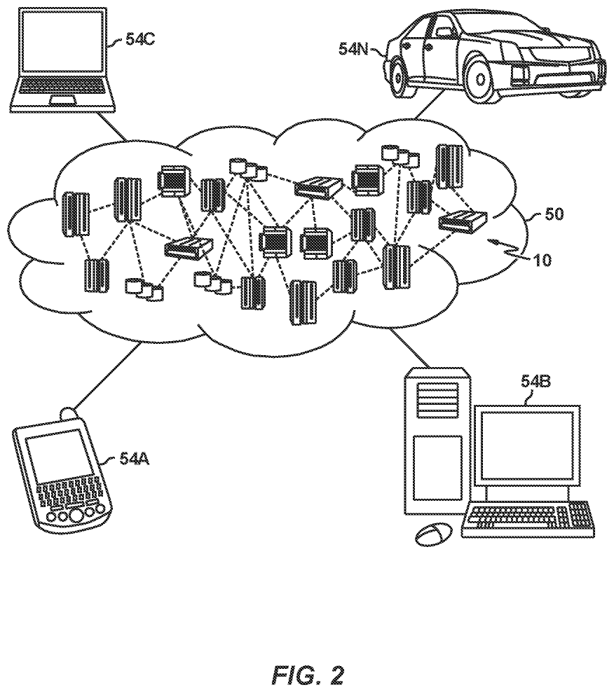

Referring now to FIG. 2, illustrative cloud computing environment 50 is depicted. As shown, cloud computing environment 50 includes one or more cloud computing nodes 10 with which local computing devices used by cloud consumers can communicate, for example, personal digital assistant (PDA) or cellular telephone 54A, desktop computer 54B, laptop computer 54C, and/or automobile computer system 54N, may communicate with one another. Cloud computing nodes 10 may be grouped (not shown) physically or virtually, in one or more networks, such as Private, Community, Public, or Hybrid clouds as described hereinabove, or a combination thereof. Grouping of nodes into a network allows cloud computing environment 50 to offer infrastructure, platforms, and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

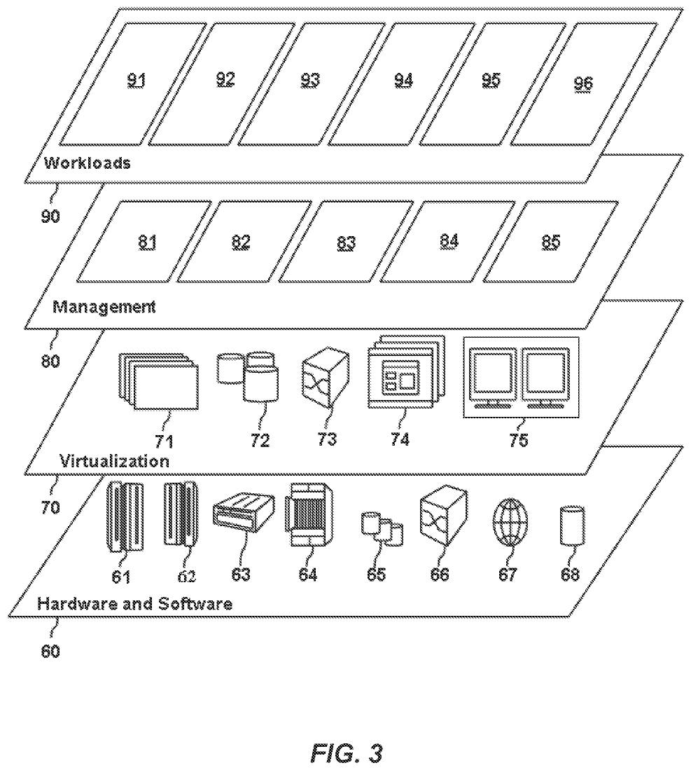

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Hardware and software layer 60 includes hardware and software components. Examples of hardware components include mainframes 61; RISC (Reduced Instruction Set Computer) architecture-based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification of cloud consumers and tasks, as well as protection of data and other resources. User portal 83 provides access to the cloud computing environment for consumers and system administrators. Service level management 84 provides cloud computing resource allocation and management such that required service levels are met. Service Level Agreement (SLA) planning and fulfillment 85 provides pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and performing an operation in a tree structure 96.

Generally, indexes can be stored in an index structure, for example, a tree structure, separately from the data table. An insertion/search/deletion operation of a record (i.e., comprised of a key and value pair) can be performed in the tree structure with its key. As the number of indexes defined in the index structure grows, an index maintenance cost during the operation also grows. The number of pages retrieved for a table or index to satisfy an SQL statement is the “get page” for the table or index. The index get page cost may be increased as the number of indices grows.

Moreover, in some cases, the database may need to traverse from a root to a leaf page (also called leaf node) in the tree structure in order to perform the operation, such as insertion, search, deletion, or the like, thereby increasing time and resource consumption.

Embodiments of the present disclosure provide a method for performing an operation in a tree structure. In the embodiments, memory spaces of the tree structure may be fully utilized for performing the operation, thereby reducing the index maintenance cost.

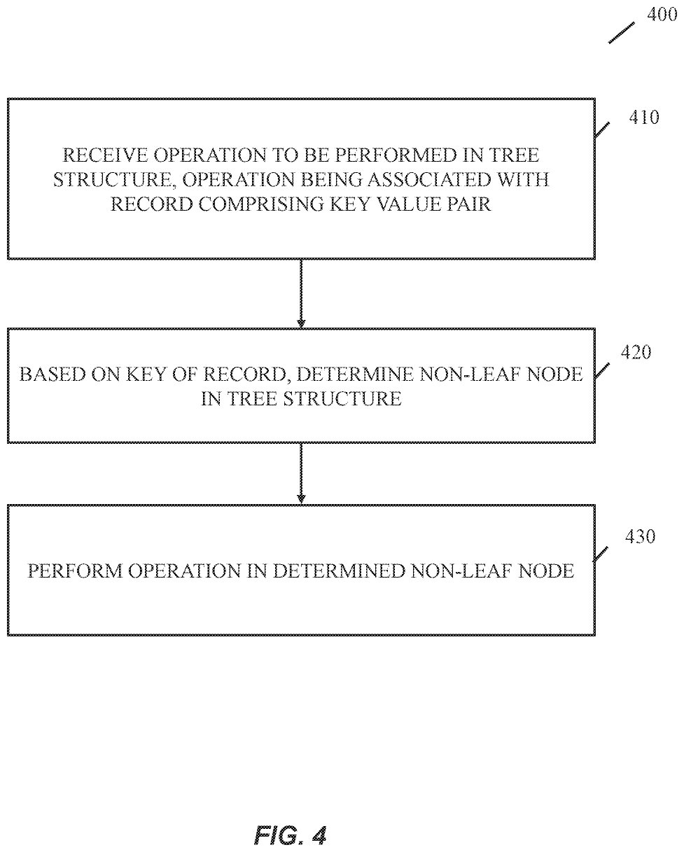

FIG. 4 depicts a schematic flowchart illustrating a method for performing an operation in a tree structure for indexing, according to some embodiments of the present disclosure.

It should be noted that the processing of the operation in the tree structure, according to embodiments of this disclosure, could be implemented by a computing device, for example, the computer system/server 13 of FIG. 1.

At block 410, the computing device receives an operation to be performed in a tree structure. The tree structure comprises a plurality of non-leaf nodes and a plurality of leaf nodes. The operation is associated with a record comprising a key and value pair.

In some embodiments, the tree structure may be stored in a memory, for example, memory 28 of FIG. 1. The computing device may retrieve the tree structure from the memory subsequent to receipt of the operation.

In some embodiments, the operation may comprise search, insertion, deletion, update, or the like. For example, the operation may be received via a request in a SQL statement. In the key-value pair, the key may be an index key value, and the value may be a data pointer which points to a storage location of the related data. The location, for example, may be a row of a data table (or a data page).

As an example, the tree structure may be a B+ tree. Specifically, the B+ tree comprises a plurality of non-leaf nodes and a plurality of leaf nodes. The B+ tree is a self-balancing tree in which all leaf nodes are arranged at a same level at the bottom. Each of the non-leaf nodes may comprise a number of keys and node pointers to its child nodes (for example, the non-leaf nodes or the leaf nodes in a deeper level). Each of the leaf nodes may comprise a number of keys and corresponding data pointers to data in a data table (or data page), resulting in all the data pointers (values) being present in the leaf nodes. Moreover, the leaf node may also comprise a node pointer to a sibling leaf node, such that the respective leaf nodes may be connected together through the node pointers.

The number of keys in the node of the B+ tree may be limited based on certain principles. When the operation is performed to the B+ tree, the number of keys in a certain node (the non-leaf node or the leaf node) may change, resulting in an overflow or underflow event that may occur when the number of keys in the node exceeds a maximum threshold or a minimum threshold of the node according to the principles for the B+ tree. Accordingly, the tree structure may be self-adjusted based on the principles.

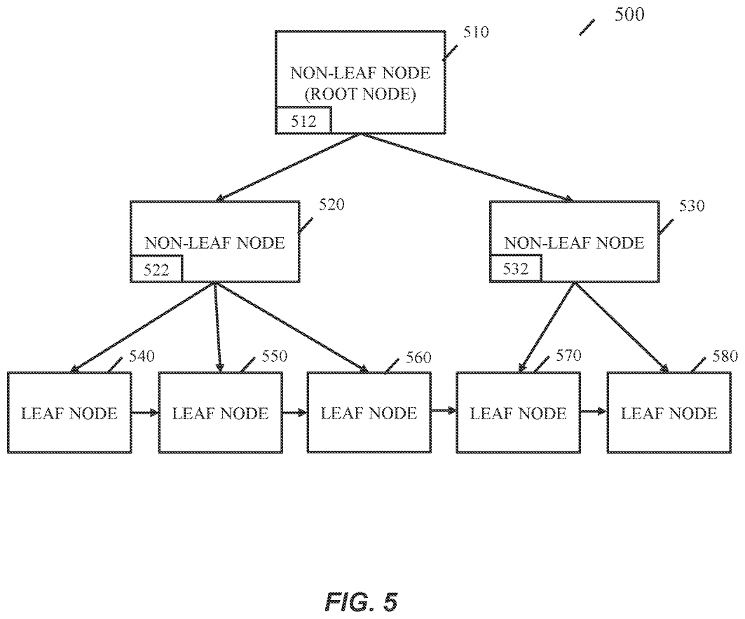

FIG. 5 depicts an illustrative diagram of a tree structure 500 according to some embodiments of the present disclosure.

As shown in FIG. 5, the tree structure 500 may comprise a plurality of nodes, such as non-leaf nodes and leaf nodes. Each of the nodes may be a page. For example, the plurality of nodes may be arranged in three levels. In the tree structure 500, the non-leaf node 510 at a first level (or the top level) may also be referred to as a root node. The non-leaf nodes 520 and 530 may be arranged in a second level. The leaf nodes 540, 550, 560, 570 and 580 may be arranged at a third level (the bottom level).

Specifically, the root node 510 may store an index key and two node pointers to the non-leaf nodes 520 and 530. The non-leaf node 520 may store index keys and node pointers to the leaf nodes 540, 550 and 560. The non-leaf node 530 may store index keys and node pointers to the leaf nodes 570 and 580. The respective leaf nodes 540, 550, 560, 570, 580 may store index keys and node pointers to their sibling leaf nodes and the data pointers included in the respective leaf nodes. The data pointers of leaf nodes point to a storage location of data associated with the corresponding key of the pair.

Moreover, the respective non-leaf nodes 510, 520 and 530 may comprise additional memory space for caching operations. For example, the additional memory space may form a cache, which may be used to store one or more records. As shown in FIG. 5, the root node 510 may comprise a cache 512. The non-leaf node 520 may comprise a cache 522. The non-leaf node 530 may comprise a cache 532. The record may comprise a key-value pair. The key of the record may be the index key value, and the value may be a data pointer which points to a storage location for the corresponding data.

Furthermore, the tree structure may not be limited to the three-level structure shown in FIG. 5. The non-leaf nodes may also be arranged in more than two levels. Less complex examples are included, herein, for brevity.

Back to FIG. 4, at block 420, the computing device determines one of the non-leaf nodes, based on the key of the record.

In some embodiments, the computing device may determine the non-leaf node by comparing the key of the record with keys in the non-leaf nodes.

For example, the operation may be configured as an insertion operation, for example, for inserting the record into the tree structure. In this situation, the computing device may search for a certain non-leaf node by comparing the key of the record and keys stored in the respective non-leaf nodes, for example, from the root node to at least one deeper non-leaf node (child node, grandchild node, or the like).

As shown in FIG. 5, for example, the computing device may compare the key of the record with the key(s) stored in the root node 510, to determine which of the non-leaf nodes at the second level may be used for storing the record. For example, if the value of the key of the record is less than the key in the root node 510, the computing device may choose the non-leaf node 520 (left to the root node 510). Otherwise, if the value of the key of the record is greater than the key in the root node 510, the computing device may choose the non-leaf node 530 (right to the root node 510).

In some embodiments, the computing device may also determine whether the cache of the non-leaf node is empty. If the cache of the non-leaf node is not empty, the computing device may determine that such non-leaf node can be used to cache the record. Otherwise, if the cache is empty, the computing device may push down the determination process to a corresponding deeper non-leaf node. Therefore, the computing device may choose the deeper non-leaf node for caching of the record if both caches of the non-leaf nodes are available. Furthermore, the computing device may also determine whether the cache of the non-leaf node is full. If the non-leaf node is full, the computing device may choose the non-leaf node at a higher level to cache the record.

For each non-leaf node utilized for caching, the non-leaf node may comprise a number of caching blocks. The number of the caching blocks may correspond to a number of its child non-leaf nodes. In some embodiments, the computing device may further determine which caching block may be used to perform the operation. Moreover, the computing device may determine whether the caching block of the cache of the non-leaf node is empty or full.

In another example, the operation may be configured as a deletion operation, for example, for deleting the record from the tree structure. Specifically, the record may be stored in a cache of a certain non-leaf node. Thus, the computing device may search for the certain non-leaf node which stores the record, based on its key.

Moreover, the operation may be configured as an update operation, such as updating the value of the record in the tree structure. For example, the record may be stored in a cache of a certain non-leaf node. Similar with the process regarding to the deletion operation, the computing device may search for the certain non-leaf node which stores the record, based on its key.

At block 430, the computing device performs the operation in the determined non-leaf node.

In some embodiments, when the operation is the insertion operation, the computing device may store the record in the cache of the determined non-leaf node. Further, if the cache has several caching blocks corresponding to the child nodes, the computing device may store the record in the corresponding caching block of the determined non-leaf node.

Furthermore, the computing device may insert the record into the tree structure based on an ascending order of the key. Therefore, the keys in a same non-leaf node are in an ascending order. The ascending order may provide a benefit for maintaining the sequence of the keys.

In some embodiments, when the operation is the deletion operation, the computing device may delete the record from the cache of the determined non-leaf node.

Moreover, when the operation is the update operation, the computing device may update the value of the record in the cache of the determined non-leaf node.

Accordingly, the memory space of the non-leaf nodes may be fully utilized to perform the operation in the tree structure. As the operation can be performed in the non-leaf node, there is no need to traverse from the root node all the way to the corresponding leaf node, and time costs can be saved.

Moreover, as the operation is performed in the cache of the non-leaf nodes, the tree structure may be maintained during the operation, thereby reducing the number of adjustments of the tree structure.

In further embodiments, the records stored in the cache of the non-leaf nodes can be merged into the respective leaf nodes, to form a conventional tree structure. For example, the computing device may merge the record in the non-leaf node to the leaf node in an appropriate time scheme.

In an aspect of the disclosure, the computing device may merge the records in the non-leaf node into the corresponding leaf nodes asynchronously, based on a timer and/or a time interval. In some embodiments, the timer and/or the time interval may be specified by a user or predetermined based on actual needs.

In another aspect, the computing device may merge the records in the non-leaf node into the corresponding leaf nodes during a read operation. For example, the computing device may receive a read operation for reading a record from the tree structure. Thus, the computing device may merge the record into the corresponding leaf node, such that the key and value of the record may be stored in the leaf node of the tree structure. Thus, the computing device may read the data pointer from the leaf node based on the key.

Moreover, the computing device may receive a read operation for batch reading a plurality of records from the tree structure. One or more records of the plurality of records may be stored in the cache of the non-leaf nodes. Thus, the computing device may merge the one or more records into the leaf node and read the plurality of records based on the data pointers in the leaf nodes.

It is to be understood that the above two merging method may be used individually or in combination. For example, the computing device may merge only the records to be read to the leaf nodes during the read operation, and then merge other records stored in the cache to the leaf node based on the timer and/or the time interval.

Subsequent to the merging operation, the tree structure may be rearranged, based on the principle for the tree structure.

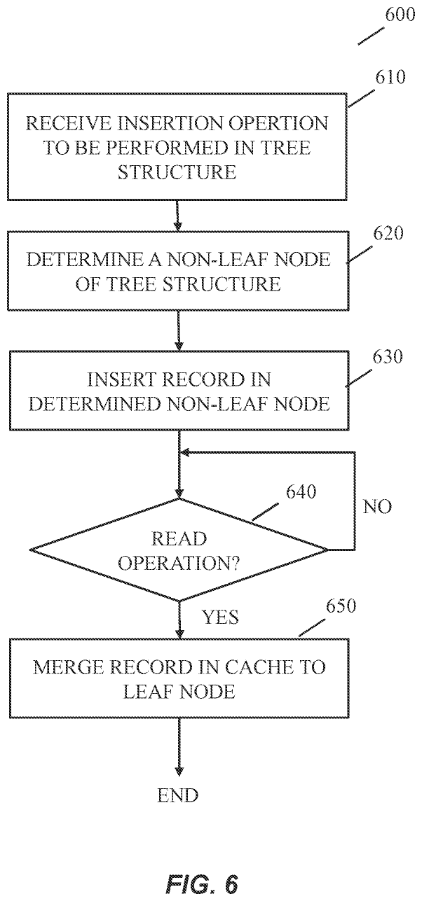

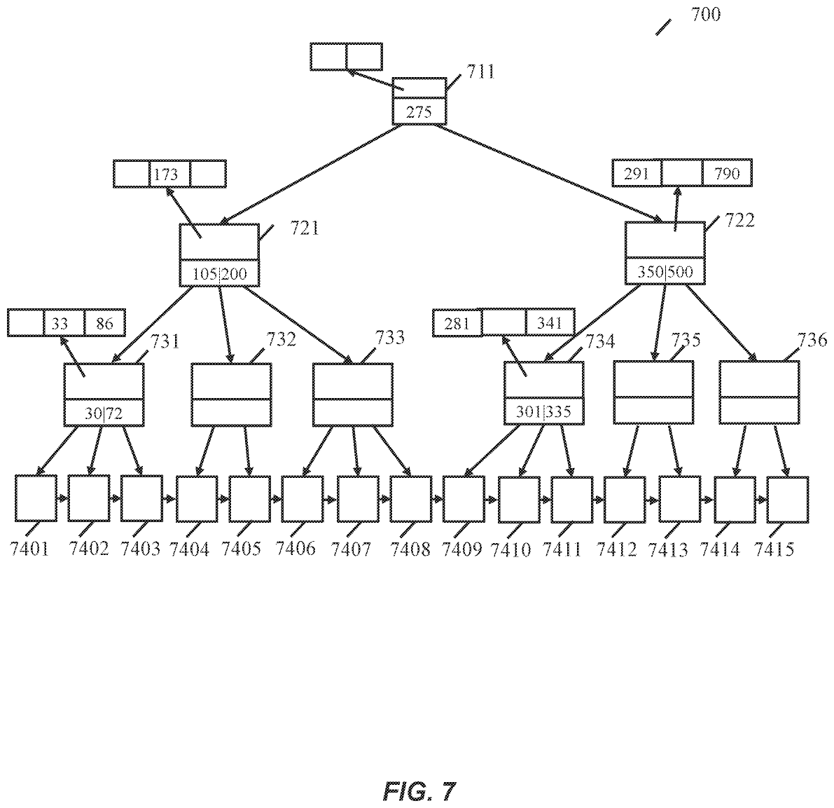

FIG. 6 depicts a schematic flowchart illustrating an exemplary process 600 of an insertion operation, for example, in a B+ tree, according to some embodiments of the present disclosure. FIG. 7 depicts an illustrative diagram of a B+ tree 700 according to some embodiments of the present disclosure. For example, the process 600 may be described with respect to the B+ tree 700.

At block 610, the computing device may receive an insertion operation for inserting a record into the B+ tree 700. For example, the record may comprise a key 300 and a data pointer to the corresponding data in a data table (e.g., in a database).

At block 620, the computing device may determine a non-leaf node of the tree structure. For example, the computing device may compare the key of the record (i.e., 300) with the key stored in the root node (i.e., 275). As 300 is greater than 275, the computing device may continue the process at the non-leaf node 722, which is to the right of the root node in FIG. 7.

As shown in FIG. 7, the non-leaf node 722 stores two keys 350 and 500, and three node pointers, each pointing to its child nodes, (i.e., non-leaf nodes 734, 735 and 736). The cache of the non-leaf node 722 may comprise three caching blocks. The computing device may compare the key of the record (i.e., 300) with the keys in the non-leaf node 722 (i.e., 350, 500). As 300 is less than the key 350, the computing device may determine that the left caching block of the non-leaf node 722 may be an option for caching the record.

Further, the computing device may determine whether the left caching block is empty. FIG. 7 illustrates that the left caching block of non-leaf node 722 includes key 291 with a blank middle block and the right cache block occupied by key 790. The key 300 can be inserted in the middle cache block of non-leaf node 722, maintaining sequence between key 291 and key 790. As an alternate example, if the left caching block of non-leaf node 722 is determined to be empty (not shown), the computing device may push down the determination process to the corresponding deeper non-leaf node, non-leaf node 734. In the alternative example, the computing device may compare the key of the record (i.e., 300) with the keys stored in the non-leaf node 734 (i.e., 301, 335). As 300 is smaller than 301, the computing device may determine the left caching block of the non-leaf node 734 may also be an option for caching the record.

The computing device determines the caching block of the non-leaf node 734 has stored key 281, and key 341 and, as such, the caching block is not yet full. The computing device may choose to insert key 300 in the caching block of the non-leaf node 734.

At block 630, the computing device may insert the record into the determined non-leaf node, for example, in sequence. For example, the computing device may store the record with the key 300 after the key 281 in the caching block of the non-leaf node 734 but before key 341, maintaining an ascending order.

At block 640, the computing device may determine whether there is a read operation for reading the record from the B+ tree 700. For example, if the computing device receives a read operation for reading the data corresponding to the key 300 (as above, in the leaf caching block of the non-leaf node 734), the process goes to block 650, the computing device may merge the record with the key 300 into the corresponding leaf node of the B+ tree, for example, the non-leaf node 7410. Further, the computing device may read the data pointer to retrieve the corresponding data. Moreover, though not shown, the merge operation may further be performed based on a timer or a time interval. FIG. 7 includes additional leaf nodes 7401-7408, and 7410-7415 in order to depict a more complete example of the B+ tree structure and embodiments of the disclosure. The additional leaf nodes are not otherwise discussed in detail. Additionally, keys 33, 86, (cache block of non-leaf node 731) and key 800 (cache block of non-leaf node 722), depicted as stored in cache of FIG. 7 are included as example cached storage of record keys and are not otherwise discussed in detail.

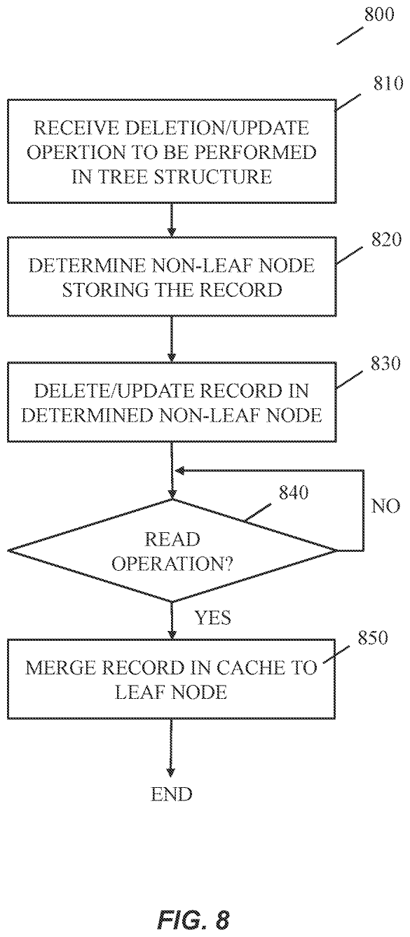

FIG. 8 depicts a schematic flowchart illustrating an exemplary process of a deletion/update operation according to some embodiments of the present disclosure. For example, the process 800 may also be described with respect to the B+ tree 700.

At block 810, the computing device may receive a deletion/update operation for delete/update a record from/in the tree structure. For example, the record may comprise a key 173. At block 820, the computing device may determine a non-leaf node of the tree structure storing the key. For example, the computing device may determine the record with a key 173 is stored in the non-leaf node 721.

At block 830, the computing device may delete the record from the determined non-leaf node in response to the deletion operation. Alternatively, the computing device may update a value of the record in the determined non-leaf node in response to the update operation. At block 840, the computing device may determine whether there is a read operation. If yes, the process goes to block 850, the computing device may merge the corresponding records in the caches of the non-leaf node into the leaf node of the tree structure. Moreover, though not shown, the merge operation may further be performed based on a timer or a time interval.

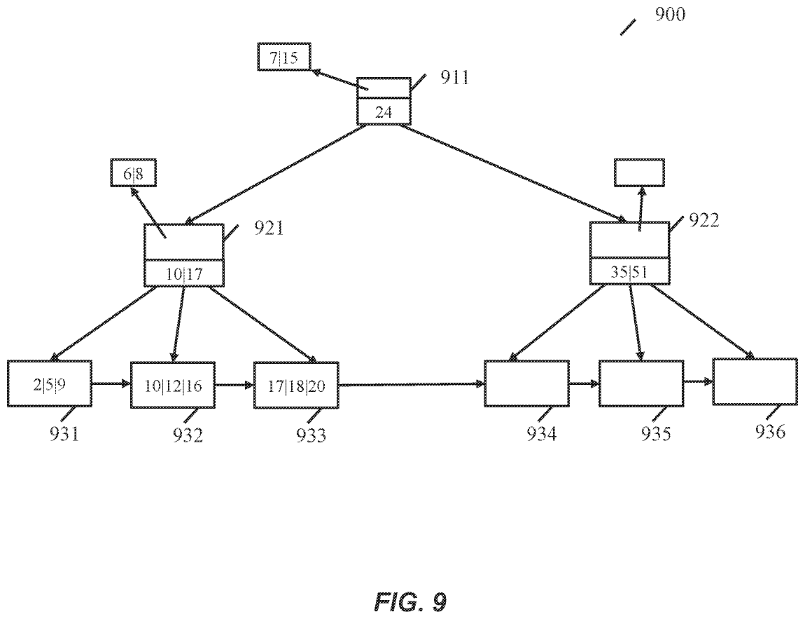

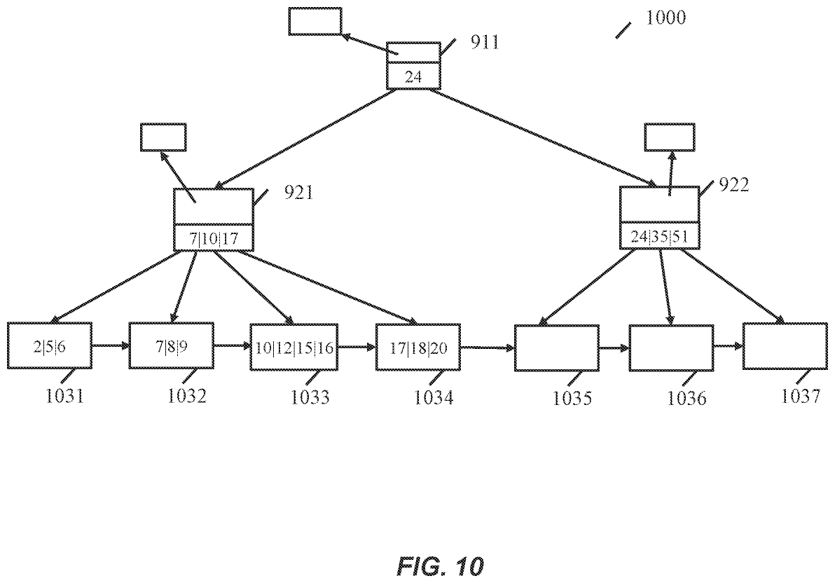

The process of merging operation now may be described with respect to an example, as shown in FIG. 9 and FIG. 10.

FIG. 9 depicts an illustrative diagram of a B+ tree according to some embodiments of the present disclosure. The non-leaf nodes in the B+ tree may comprise a root node 911, a first non-leaf node 921 and a second non-leaf node 922. As FIG. 9 shows, the root node 911 at a first level stores a key 24 and two pointers. One pointer may point to a first non-leaf node 921, and the other one may point to a second non-leaf node 922, which are arranged at a second level. The first non-leaf node 921 stores two keys 10 and 17 and three pointers, pointing to leaf nodes 931, 932 and 933.

Moreover, the root node 911, the first non-leaf node 921 and the second non-leaf node 922 may respectively comprise a cache. For example, the cache of the root node 911 may store a record comprising a key 7 and a record comprising a key 15. The cache of the first non-leaf node 921 may store a record comprising a key 6 and a record comprising a key 8. As shown in FIG. 9, the records in each cache are arranged in an ascending order.

The leaf node 931 stores three keys 2, 5, 9, corresponding data pointers, and a node pointer pointing to the leaf node 932. The leaf node 932 stores three keys 10, 12, 16, corresponding data pointers, and a node pointer pointing to the leaf node 933. The leaf node 933 stores three keys 17, 18, 20, corresponding data pointers, and a node pointer pointing to a next leaf node. For simplicity and brevity, additional nodes of the B+ tree 900 are included for a more representative example of the tree structure, however, details and description of the additional nodes (934, 935, and 936) and keys 35 and 51 of non-leaf node 922 are omitted for brevity.

In some embodiments, the computing device may receive a read operation for the B+ tree 900. The read operation may be a batch read operation, for example, for reading a range of keys [5, 18]. The computing device may merge the respective records in the caches into the leaf nodes subsequent to the read operation, based on a general process of the B+ Tree principles, determining how and which records to set into which nodes, and may consider node size and record size. The read operation benefits from accessing key record pointers in cache, thus avoiding “get page” calls and resulting in more efficiency of record keys inserted in non-leaf node cache blocks.

For example, the computing device may find keys larger than 5 in the leaf nodes, and firstly locate the leaf node 931 (which may comprise the keys 5, 9). The computing device may then locate the keys 6, 7, 8 stored in the caches of non-leaf nodes 911 and 921. The computing device may thus read data based on the data pointers corresponding to the keys [5, 6, 7, 8, 9]. The general processing of the B+ Tree structure may determine that the keys and pointers located in the cache of non-leaf nodes (i.e., keys 6, 7, 8) should be merged into the leaf node 931.

The computing device may subsequently find the keys larger than 9, locating the leaf node 932, which includes the keys [10, 12, 16]. The computing device may determine that the record with the key 15 should be merged into the leaf node 932. Thus, the computing device may read data based on the data pointers corresponding to the keys [10, 12, 15, 16], merging record key 15 into leaf node 932.

The computing device may continue and find the keys larger than 16, locating the leaf node 933, which may include the keys [17, 18] (key 20 is outside the range of the read operation [5, 18]). The computing device may read data based on the data pointers corresponding to the keys [17, 18] at which point the read and merging process ends.

The read and merging process finishes. The batch read operation may reduce the time and IO costs during the read and merge operation, as the data can be read in a batch, and “get page” counts may be reduced.

An overflow event may occur as a result of inserting records in the leaf nodes. As the B+ tree is a self-balancing tree, the B+ tree may be self-adjusted, for example, to split the leaf node 931 (which stores the keys 2, 5, 6, 7, 8, 9 after merging) to a leaf node which stores the keys 2, 5, 6 and another leaf node which stores the keys 7, 8, 9. In some embodiments of the disclosure, the key 7 may also be added in the non-leaf node 921, as B+ Trees, which are a variant of the B-Tree, have key values stored in internal nodes that also appear in leaf nodes. FIG. 10 depicts an illustrative diagram of a B+ tree 1000 according to some embodiments of the present disclosure. The B+ tree 1000 may be generated after merging the records into the leaf nodes based on the read operation in FIG. 9. The leaf node 1034 is generated by a general process of the B+ Tree resulting from a split of record keys merged into leaf node 931 shown in FIG. 9. The additional leaf node balances the keys as shown in leaf nodes 1032, 1033, and 1034.

In some embodiments, there may be other records in the caches which are not merged into the leaf nodes during the read operation. Thus, for those records, the computing device may merge them based on a specified timer, time interval, or until the next read operation.

According to embodiments of the present disclosure, memory spaces (i.e., msg cache) of the tree structure may be fully utilized, to reduce the index maintenance costs. Thus, the time and resource consumption during the insertion/deletion/update operations may be reduced.

Additionally, in some embodiments of the present disclosure include an apparatus for performing an operation in a tree structure. The apparatus may comprise one or more processing units, a memory coupled to at least one of the processing units, and a set of computer program instructions stored in the memory. The set of computer program instructions may be executed by at least one of the processing units to perform the above method.

In some embodiments of the present disclosure, a computer program product for performing an operation in a tree structure is disclosed. The computer program product may comprise a computer readable storage medium having program instructions embodied therewith. The program instructions executable by a processor causes the processor to perform the above method.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer implemented method, comprising:
receiving, by one or more processing units, an operation to be performed in a tree structure, wherein the tree structure comprises a plurality of non-leaf nodes and a plurality of leaf nodes, and the operation is associated with a record comprising a pair of a key and a value;
determining, by one or more processing units, one of the non-leaf nodes, based on the key of the record; and
performing, by one or more processing units, the operation in the determined non-leaf node.

2. The computer implemented method according to claim 1, wherein the operation includes inserting the record into the tree structure and the determination of the one of the non-leaf nodes based on the key of the record further comprises:
comparing, by one or more processing units, the key of the record with keys stored in the plurality of non-leaf nodes, respectively.

3. The computer implemented method according to claim 1, wherein performing the operation in the determined non-leaf node further comprises:
storing, by one or more processing units, the record in a cache of the determined non-leaf node.

4. The computer implemented method according to claim 1, wherein a cache of the determined non-leaf node comprises a number of caching blocks, each corresponding to a child node of the non-leaf node, and wherein the record is stored in one of the caching blocks based on the key of the record.

5. The computer implemented method according to claim 1, further comprises:
storing, by one or more processing units, the key of the record in a cache of the determined non-leaf node; and
arranging, by one or more processors, the key of the record such that two or more keys of records are in an ascending order.

6. The computer implemented method according to claim 1, wherein the operation is configured to delete the record from the tree structure, further comprises:
determining, by one or more processing units, the non-leaf node that includes a cache storing the key of the record to be deleted; and
deleting, by one or more processing units, the record from the determined non-leaf node.

7. The computer implemented method according to claim 1, wherein the operation is configured to update the value of the record in the tree structure, further comprises:
determining, by one or more processing units, one of the non-leaf nodes that includes a cache storing the key of the record; and
updating, by one or more processing units, the value of the record in the cache of the determined non-leaf node.

8. The computer implemented method according to claim 1, further comprising:
receiving, by one or more processing units, a read operation to read one or more records in the tree structure, wherein at least one record of the one or more records is stored in a cache of one of the non-leaf nodes;
merging, by one or more processing units, the at least one record stored in the cache of the one of the non-leaf nodes to a corresponding leaf node; and
reading, by one or more processing units, data based on one or more values of the one or more records.

9. The computer implemented method according to claim 1, wherein at least one record is stored in a cache of one of the non-leaf nodes, the method further comprising:
merging, by one or more processing units, the one or more records stored in the cache of the non-leaf nodes to the leaf node corresponding to the cache, based on a timer.

10. An apparatus, comprising:
one or more processors;
a memory coupled to at least one of the one or more processors; and
a set of computer program instructions stored in the memory and executed by at least one of the one or more processors in order to perform actions of:
receiving an operation to be performed in a tree structure, wherein the tree structure comprises a plurality of non-leaf nodes and a plurality of leaf nodes, and the operation is associated with a record comprising a pair of a key and a value, wherein the key identifies a record associated with the operation and the value includes a pointer to the record in memory;
determining one of the non-leaf nodes, based on the key of the record; and
performing the operation in the determined non-leaf node.

11. The apparatus of claim 10, wherein the operation is configured to insert the record into the determined non-leaf node further comprises:
comparing the key of the record with keys stored in the respective non-leaf nodes.

12. The apparatus of claim 10, wherein performing the operation in the determined non-leaf node comprises:
storing the record in a cache of the determined non-leaf node.

13. The apparatus of claim 12, wherein at least one key is stored in the cache of the determined non-leaf node, and wherein additionally storing the record in the cache of the determined non-leaf node comprises:
storing the key of the record in the cache of the determined non-leaf node, such that the keys are arranged in an ascending order.

14. The apparatus of claim 10, wherein the operation is configured to delete the record from the tree structure, and wherein determining one of the non-leaf nodes based on the key of the record comprises:
determining one of the non-leaf nodes, which comprises a cache storing the key of the record; and
deleting the record from the determined non-leaf node.

15. The apparatus of claim 10, wherein the operation is configured to update a value of the record in the tree structure, and wherein determining one of the non-leaf nodes based on the key of the record comprises:
determining the non-leaf node that includes a cache storing the key of the record; and
performing the operation in the determined non-leaf node by updating the value of the record in the cache of the determined non-leaf node.

16. The apparatus of claim 10, further comprising:
receiving a read operation to read one or more records in the tree structure;
determining the one of the non-leaf nodes including the one or more records to be read, based on the respective key associated with the one or more records, wherein at least one record of the one or more records is stored in a cache of one of the non-leaf nodes;
merging the at least one record stored in the cache of the non-leaf node to the corresponding leaf node of the one of the non-leaf nodes; and
reading data based on one or more values of the one or more records, respectively.

17. The apparatus of claim 10, wherein at least one record is stored in a cache of one of the non-leaf nodes, wherein the read operation further comprises:
merging the one or more records to the leaf nodes based on a timer.

18. A computer program product, comprising:
a computer readable storage medium having program instructions embodied therewith, the program instructions executable by a one or more processors to cause the one or more processors to:
receive an operation to be performed in a tree structure, wherein the tree structure comprises a plurality of non-leaf nodes and a plurality of leaf nodes, and the operation is associated with a record comprising a pair of a key and a value, wherein the key identifies a record associated with the operation and the value includes a pointer to the record in memory;
determine one of the non-leaf nodes, based on the key of the record; and
perform the operation in the determined non-leaf node.

19. The computer program product of claim 18, wherein the operation is configured to insert the record into the tree structure further comprising:
determining the one of the non-leaf nodes by comparing the key of the record with keys stored in the respective non-leaf nodes; and
performing the operation to insert the record in the determined one of the non-leaf nodes and storing the record in a cache of the determined non-leaf node.

20. The computer program product of claim 18, wherein the received operation further comprises:
receiving a read operation to read one or more records in the tree structure, wherein at least one record of the one or more records is stored in a cache of one of the non-leaf nodes;
merging the at least one record stored in the cache of the non-leaf node to the corresponding leaf node; and
reading data based on one or more value of the one or more records.
